(19) United States
(12) Patent Application Publication
(10) Pub. No.: US 2024/0365052 A1
(43) Pub. Date: Oct. 31, 2024

(54) SPEAKER

(71) Applicant: OMVO TECHNOLOGY INC., Zhubei City (TW)

(72) Inventors: YUE SHIH JENG, Zhubei City (TW); CHAO HUA WEN, Toufen City (TW); HSUEH CHING SHIH, Hsinchu City (TW)

(21) Appl. No.: 18/585,073

(22) Filed: Feb. 23, 2024

(30) Foreign Application Priority Data
Apr. 28, 2023 (TW) 112115998

(51) Int. Cl. H04R 1/28; H04R 1/02; H04R 7/04; H04R 7/18; H04R 17/00

(52) U.S. Cl. CPC H04R 1/2826; H04R 1/025; H04R 7/04; H04R 7/18; H04R 17/00; H04R 2307/025

(57) ABSTRACT

A speaker includes a telescopic sound chamber, a first diaphragm, and a first piezoelectric vibrating element. The telescopic sound chamber has a box wall, a bottom layer, and a first opening. The telescopic sound chamber includes a plurality of telescopic sub-box layers sleeved on and connected to each other and decreasing in volume layer by layer. The telescopic sound chamber accommodates the smaller telescopic sub-box layer into the larger telescopic sub-box layer to reduce the volume of the telescopic sound chamber. The telescopic sound chamber moves the smaller telescopic sub-box layer away from the larger telescopic sub-box layer to increase the volume of the telescopic sound chamber. The first diaphragm is arranged on the box wall to cover the first opening. The speaker can improve the drawbacks of low-frequency range distortion and has the advantages of full audio, high volume, and smooth sound pressure.

### FIELD OF THE INVENTION

The present invention relates to a speaker, and more particularly to a piezoelectric speaker.

### BACKGROUND OF THE INVENTION

Speakers are very common in daily life, from small wireless headphones, cell phone speakers, to large stage or theater sound equipment, etc. In use, the good or bad sound quality of speakers can seriously affect the accuracy of sound and the user's perception, while full-range audio speakers have a more precise and more natural sound reproduction than cross-over audio speakers.

Compared to conventional speakers in which the process of converting electrical energy into magnetic energy and then mechanical energy is prone to sound distortion caused by energy loss, the piezoelectric speakers utilize the piezoelectric materials to directly convert electrical energy into mechanical energy, which can improve energy conversion efficiency. However, at present, the piezoelectric speakers are limited by their structure, which can cause energy loss and structural resonance during the transmission of vibration energy, resulting in unstable sound pressure output. Especially in the low-frequency range, the piezoelectric speakers can have significant distortion, which makes them mostly suitable for high-frequency speakers, and therefore their practicality is not high.

### SUMMARY OF THE INVENTION

The present invention provides a speaker that utilizes a closed variable volume air chamber design, which not only retains the advantages of the piezoelectric speakers in the high-frequency range but also overcomes the disadvantages in the low-frequency range. Therefore, the piezoelectric speaker can produce a more natural and closer to the original sound, with the advantages of full audio, high volume, and smooth sound pressure level (SPL).

The first aspect of the present invention provides a speaker, which includes a telescopic sound chamber, a first diaphragm, and a first piezoelectric vibrating element. The telescopic sound chamber has a box wall, a bottom layer, and a first opening. The bottom layer and the first opening are opposite to each other. The telescopic sound chamber includes a plurality of telescopic sub-box layers. The telescopic sub-box layers are sleeved on and connected to each other. The telescopic sub-box layers decrease in volume layer by layer. The telescopic sound chamber is suitable for accommodating the relatively smaller telescopic sub-box layer into the respective relatively larger telescopic sub-box layer to reduce a volume of the telescopic sound chamber. The telescopic sound chamber is suitable for moving the relatively smaller telescopic sub-box layer away from the respective relatively larger telescopic sub-box layer to increase the volume of the telescopic sound chamber. At least one of the box wall and the bottom layer is formed with at least one air pressure regulating hole. The first diaphragm is arranged on the box wall to cover the first opening. The first piezoelectric vibrating element is arranged on the first diaphragm, faces the bottom layer, and is accommodated in the telescopic sound chamber.

In an embodiment of the present invention, the volumes of the telescopic sub-box layers decrease layer by layer in a direction from the first opening to the bottom layer.

In an embodiment of the present invention, the volumes of the telescopic sub-box layers decrease layer by layer in a direction from the bottom layer to the first opening.

In an embodiment of the present invention, each of the telescopic sub-box layers has a rectangular or trapezoidal outline on a longitudinal plane of a direction from the first opening to the bottom layer.

In an embodiment of the present invention, the aforementioned speaker further includes a first connecting adhesive layer arranged between the first piezoelectric vibrating element and the first diaphragm.

In an embodiment of the present invention, the aforementioned speaker further includes a first support element arranged around a circumference of the first diaphragm. The first diaphragm is connected to the box wall through the first support element to cover the first opening.

In an embodiment of the present invention, the bottom layer seals an end of the telescopic sound chamber far from the first opening, and the at least one air pressure regulating hole is formed on the bottom layer.

In an embodiment of the present invention, a material of the box wall and a material of the bottom layer are the same, and the box wall and the bottom layer are integrally formed.

In an embodiment of the present invention, a material of the box wall and a material of the bottom layer are different, and the bottom layer is attached to the box wall.

In an embodiment of the present invention, the telescopic sound chamber has a minimum volume by accommodating the relatively smaller telescopic sub-box layer into the respective relatively larger telescopic sub-box layer layer by layer. The first diaphragm covering the first opening has a first coverage area. The first diaphragm has a first diaphragm thickness. The first piezoelectric vibrating element has a first element thickness. A sum of the first diaphragm thickness and the first element thickness is a first total thickness. A product of the first coverage area and the first total thickness defines a first spatial volume, and the minimum volume is greater than twice the first spatial volume.

In an embodiment of the present invention, the box wall has a box wall thickness, the box wall thickness is greater than twice the first element thickness, and the first diaphragm thickness is less than or equal to the first element thickness.

In an embodiment of the present invention, the aforementioned speaker further includes a second diaphragm and a second piezoelectric vibrating element. A second opening is formed on the bottom layer of the telescopic sound chamber. The second opening is opposite to the first opening. The second diaphragm is arranged on the box wall to cover the second opening. The second piezoelectric vibrating element is arranged on the second diaphragm, faces the first opening, and is accommodated in the telescopic sound chamber. The at least one air pressure regulating hole is formed on the box wall.

In an embodiment of the present invention, a quantity of the at least one air pressure regulating hole is plural. The air pressure regulating holes at least are symmetrically formed on a part of the box wall corresponding to the largest telescopic sub-box layer.

In an embodiment of the present invention, the aforementioned speaker further includes a second connecting adhesive layer arranged between the second piezoelectric vibrating element and the second diaphragm.

In an embodiment of the present invention, the aforementioned speaker further includes a second support element arranged around a circumference of the second diaphragm. The second diaphragm is connected to the box wall through the second support element to cover the second opening.

In an embodiment of the present invention, the telescopic sound chamber has a minimum volume by accommodating the relatively smaller telescopic sub-box layer into the respective relatively larger telescopic sub-box layer layer by layer. The first diaphragm covering the first opening has a first coverage area. The second diaphragm covering the second opening has a second coverage area. The first diaphragm has a first diaphragm thickness. The second diaphragm has a second diaphragm thickness. The first piezoelectric vibrating element has a first element thickness. The second piezoelectric vibrating element has a second element thickness. A sum of the first diaphragm thickness and the first element thickness is a first total thickness. A sum of the second diaphragm thickness and the second element thickness is a second total thickness. A product of the first coverage area and the first total thickness defines a first spatial volume. A product of the second coverage area and the second total thickness defines a second spatial volume. The minimum volume is greater than twice a sum of the first spatial volume and the second spatial volume.

In an embodiment of the present invention, the box wall has a box wall thickness, the box wall thickness is greater than twice the second element thickness, and the second diaphragm thickness is less than or equal to the second element thickness.

In an embodiment of the present invention, a material of the first diaphragm and the second diaphragm is polyethylene or polypropylene, and a material of the box wall is polyethylene, polypropylene, or paper.

In an embodiment of the present invention, a structure of the box wall is solid, hollow, or honeycomb-like.

In an embodiment of the present invention, a rigidity of the box wall is greater than or equal to a rigidity of the first diaphragm, and the rigidity of the box wall and the rigidity of the first diaphragm are between 10 N/m and 200 N/m.

The second aspect of the present invention provides a speaker, which includes a telescopic sound chamber, a first diaphragm, and a first piezoelectric vibrating element. The telescopic sound chamber includes a bellows tube body. The bellows tube body has a box wall, a first end, and a second end opposite to the first end. The box wall extends along an axis. The first end forms a first opening. The second end forms a bottom layer. A volume of the bellows tube body is suitable for changing with a height of the box wall in the axis. At least one of the box wall and the bottom layer is formed with at least one air pressure regulating hole. The first diaphragm is arranged on the box wall to cover the first opening. The first piezoelectric vibrating element is arranged on the first diaphragm, faces the bottom layer, and is accommodated in the telescopic sound chamber.

In an embodiment of the present invention, the aforementioned speaker further includes a first connecting adhesive layer arranged between the first piezoelectric vibrating element and the first diaphragm.

In an embodiment of the present invention, the aforementioned speaker further includes a first support element arranged around a circumference of the first diaphragm. The first diaphragm is connected to the box wall through the first support element to cover the first opening.

In an embodiment of the present invention, the bottom layer seals an end of the bellows tube body far from the first opening, and the at least one air pressure regulating hole is formed on the bottom layer.

In an embodiment of the present invention, a volume of the bellows tube body is adapted to change with a height change of the box wall along the axis, so that the telescopic sound chamber has a minimum volume. The first diaphragm covering the first opening has a first coverage area. The first diaphragm has a first diaphragm thickness. The first piezoelectric vibrating element has a first element thickness. A sum of the first diaphragm thickness and the first element thickness is a first total thickness. A product of the first coverage area and the first total thickness defines a first spatial volume. The minimum volume is greater than twice the first spatial volume.

In an embodiment of the present invention, the aforementioned speaker further includes a second diaphragm and a second piezoelectric vibrating element. A second opening is formed on the bottom layer. The second opening is opposite to the first opening. The second diaphragm is arranged on the box wall to cover the second opening. The second piezoelectric vibrating element is arranged on the second diaphragm, faces the second opening, and is accommodated in the telescopic sound chamber. The at least one air pressure regulating hole is formed on the box wall.

In an embodiment of the present invention, the aforementioned speaker further includes a second connecting adhesive layer arranged between the second piezoelectric vibrating element and the second diaphragm.

In an embodiment of the present invention, the aforementioned speaker further includes a second support element arranged around a circumference of the second diaphragm. The second diaphragm is connected to the box wall through the second support element to cover the second opening.

In an embodiment of the present invention, a quantity of the at least one air pressure regulating hole is plural, and the air pressure regulating holes at least are symmetrically formed on a part of the box wall close to the first opening and the second opening.

In an embodiment of the present invention, the telescopic sound chamber further comprises a pressure regulating layer. The pressure regulating layer is located in the telescopic sound chamber to divide the telescopic sound chamber. The pressure regulating layer is formed with a plurality of air holes.

In an embodiment of the present invention, a material of the bottom layer and the air pressure regulating layer is selected from one of metal, ceramic, glass, or woven fabric.

In an embodiment of the present invention, a volume of the bellows tube body is adapted to change with a height change of the box wall along the axis, so that the telescopic sound chamber has a minimum volume. The first diaphragm covering the first opening has a first coverage area. The second diaphragm covering the second opening has a second coverage area. The first diaphragm has a first diaphragm thickness. The second diaphragm has a second diaphragm thickness. The first piezoelectric vibrating element has a first element thickness. The second piezoelectric vibrating element has a second element thickness. A sum of the first diaphragm thickness and the first element thickness is a first total thickness. A sum of the second diaphragm thickness and the second element thickness is a second total thickness. A product of the first coverage area and the first total thickness defines a first spatial volume. A product of the second coverage area and the second total thickness defines a second spatial volume. The minimum volume is greater than twice the sum of the first spatial volume and the second spatial volume.

By adopting a telescopic sound chamber that can change the internal spatial volume, the speaker of the present invention can change the spatial volume of the air chamber accordingly, thereby improving the distortion of the piezoelectric speaker in the low-frequency range and providing features of full audio, high volume, and smooth sound pressure level (SPL).

Other objectives, features, and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1A is a schematic cross-sectional diagram of a speaker in the first embodiment of the present invention;

FIG. 1B is a schematic three-dimensional diagram of the speaker in the first embodiment of the present invention;

FIG. 1C is a schematic diagram of the speaker in the first embodiment of the present invention in which the speaker has the minimum volume;

FIG. 2 is a schematic cross-sectional diagram of a speaker in the second embodiment of the present invention;

FIG. 3 is a schematic cross-sectional diagram of a speaker in the third embodiment of the present invention;

FIG. 4 is a schematic cross-sectional diagram of a speaker in the fourth embodiment of the present invention;

FIG. 5 is a schematic cross-sectional diagram of a speaker in the fifth embodiment of the present invention;

FIG. 6 is a schematic cross-sectional diagram of a speaker in the sixth embodiment of the present invention;

FIG. 7 is a schematic cross-sectional diagram of a speaker in the seventh embodiment of the present invention;

FIG. 8A is a schematic cross-sectional diagram of a speaker in the eighth embodiment of the present invention;

FIG. 8B is a schematic three-dimensional diagram of the speaker in the eighth embodiment of the present invention; and

FIG. 8C is a schematic diagram of the speaker in the eighth embodiment of the present invention in which the speaker has the minimum volume.

### DETAILED DESCRIPTION OF PREFERRED EMBODIMENTS

Terms used in the description of the embodiments of the present invention, for example, orientation or position relation such as “above” and “below” are described according to the orientation or position relation shown in the drawings. The above terms are used for facilitating the description of the present invention rather than limiting the present invention, i.e., indicating or implying that the mentioned elements have to have specific orientations and to be configured in the specific orientations. In addition, terms such as “first” and “second” involved in the description or claims are merely used for naming the elements or distinguishing different embodiments or ranges rather than limiting the upper limit or lower limit of the quantity of the elements.

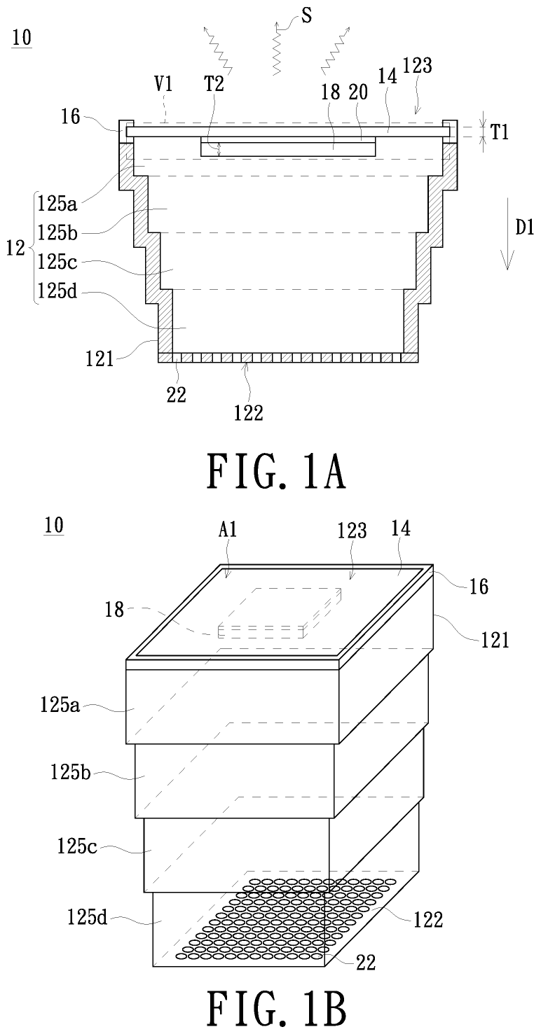

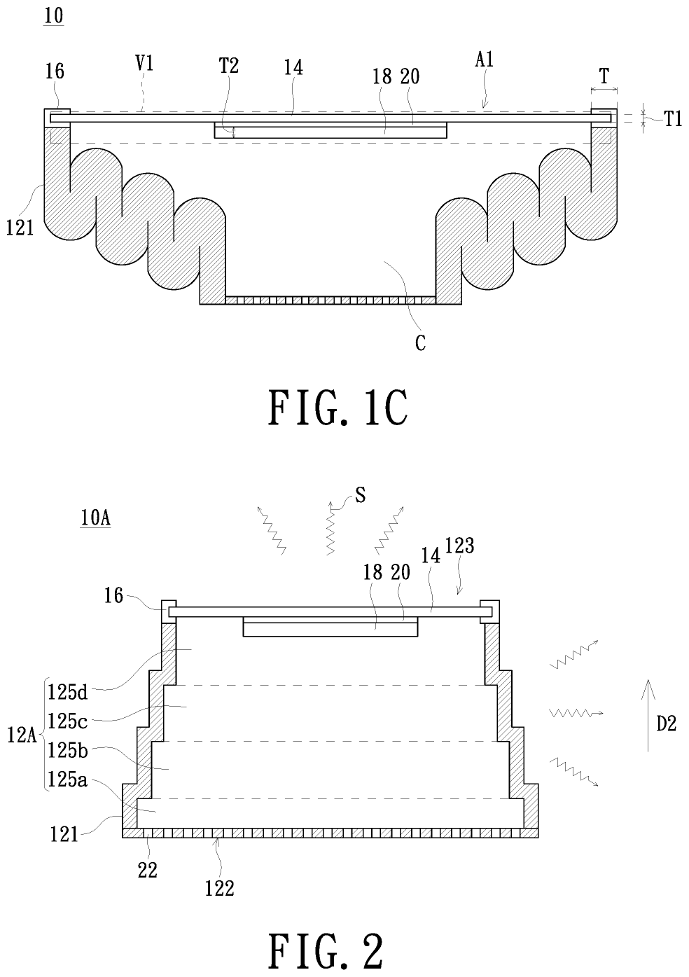

FIG. 1A is a schematic cross-sectional diagram of a speaker in the first embodiment of the present invention. FIG. 1B is a schematic three-dimensional diagram of the speaker in the first embodiment of the present invention. As shown in FIGS. 1A and 1B, the speaker 10 includes a telescopic sound chamber 12, a first diaphragm 14, and a first piezoelectric vibrating element 18. The telescopic sound chamber 12 has a box wall 121, a bottom layer 122, and a first opening 123. The bottom layer 122 and the first opening 123 are at the opposite ends of the telescopic sound chamber 12, respectively. The telescopic sound chamber 12 includes a plurality of telescopic sub-box layers, taking four telescopic sub-box layers 125a, 125b, 125c, and 125d as an example in the figures, but is not limited thereto. The bottom layer 122 is opposite to the first opening 123 and has one or a plurality of air pressure regulating holes 22. The first diaphragm 14 has a first diaphragm thickness T1. The first diaphragm 14 is arranged on the box wall 121 with a first support element 16 arranged around the circumference of the first diaphragm 14 and covers the first opening 123 to form a first coverage area A1. The first piezoelectric vibrating element 18 has a first element thickness T2. The first piezoelectric vibrating element 18 is attached to the first diaphragm 14 with a first connecting adhesive layer 20, faces the bottom layer 122, and is accommodated in the telescopic sound chamber 12. In FIG. 1A, the output of the sound source is represented by a serrated arrow S.

Continue with the above description. As shown in FIG. 1A, the four telescopic sub-box layers 125a, 125b, 125c, and 125d of the telescopic sound chamber 12 decrease in volume layer by layer in the direction D1 from the first opening 123 to the bottom layer 122. The smallest telescopic sub-box layer 125d is connected to the bottom layer 122. In another embodiment, the telescopic sub-box layers 125a, 125b, 125c, and 125d each present a rectangular outline on the longitudinal plane of the direction D1. Referring to FIGS. 1A and 1B, the sum of the first diaphragm thickness T1 and the first element thickness T2 is the first total thickness, and the product of the first coverage area A1 and the first total thickness defines the first spatial volume V1 (the part framed by the dashed line).

FIG. 1C is a schematic diagram of the speaker in the first embodiment of the present invention in which the speaker has the minimum volume. As shown in FIGS. 1A and 1C, the telescopic sub-box layers 125a, 125b, 125c, and 125d can be accommodated layer by layer to reduce the volume of the telescopic sound chamber 12. For example, the relatively smaller telescopic sub-box layer 125d can be accommodated in the relatively larger telescopic sub-box layer 125c, the relatively smaller telescopic sub-box layer 125c can be accommodated in the relatively larger telescopic sub-box layer 125b, and the relatively smaller telescopic sub-box layer 125b can be accommodated in the relatively larger telescopic sub-box layer 125a, so that the telescopic sub-box layers 125a, 125b, 125c, and 125d can be accommodated layer by layer to form the minimum volume C of the telescopic sound chamber 12. The minimum volume C of the telescopic sound chamber 12 is greater than twice the first spatial volume V1. In addition, as shown in FIG. 1C, the first diaphragm thickness T1 is less than or equal to the first element thickness T2. The box wall 121 has a box wall thickness T. In an embodiment, in order for the box wall 121 to support the first diaphragm 14, the first support element 16, and the first piezoelectric vibrating element 18 arranged above the box wall 121, the box wall thickness T is greater than twice the first element thickness T2.

FIG. 2 is a schematic cross-sectional diagram of a speaker in the second embodiment of the present invention. The difference between the speaker 10A in FIG. 2 and the speaker 10 in FIG. 1A is that in the speaker 10A shown in FIG. 2, the telescopic sub-box layers 125a, 125b, 125c, and 125d of the telescopic sound chamber 12A decrease in volume layer by layer in the direction D2 from the bottom layer 122 to the first opening 123. The largest telescopic sub-box layer 125a is connected to the bottom layer 122.

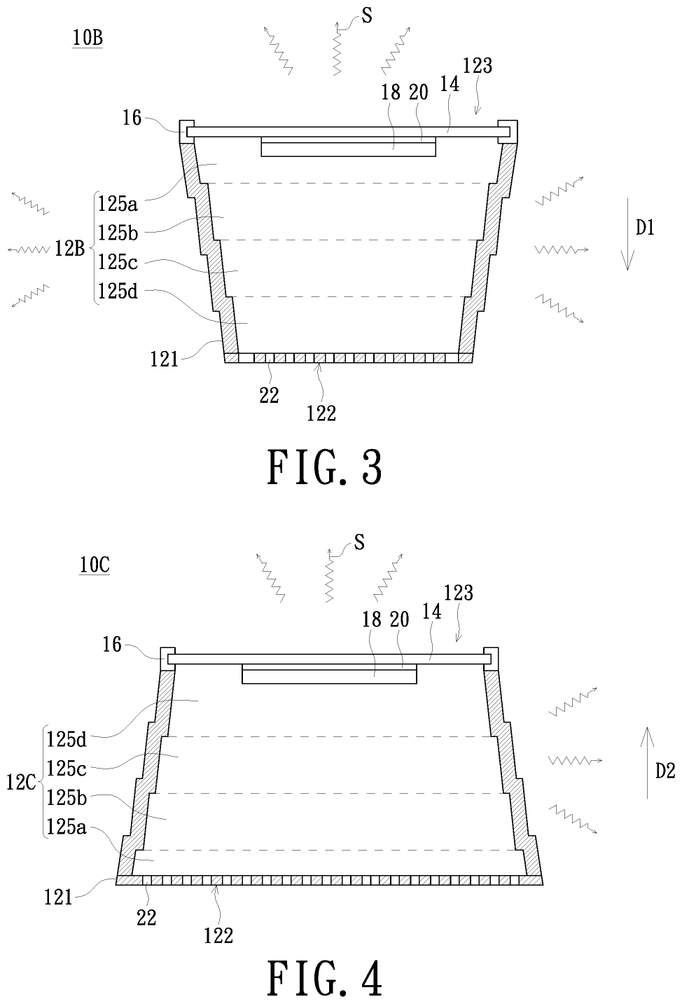

FIG. 3 is a schematic cross-sectional diagram of a speaker in the third embodiment of the present invention. The difference between the speaker 10B in FIG. 3 and the speaker 10 in FIG. 1A is that in the speaker 10B shown in FIG. 3, the telescopic sub-box layers 125a, 125b, 125c, and 125d of the telescopic sound chamber 12B each present a trapezoid outline on the longitudinal plane of the direction D1 from the first opening 123 to the bottom layer 122.

FIG. 4 is a schematic cross-sectional diagram of a speaker in the fourth embodiment of the present invention. The difference between the speaker 10C in FIG. 4 and the speaker 10A in FIG. 2 is that in the speaker 10C shown in FIG. 4, the telescopic sub-box layers 125a, 125b, 125c, and 125d of the telescopic sound chamber 12C each present a trapezoid outline on the longitudinal plane of the direction D2 from the bottom layer 122 to the first opening 123.

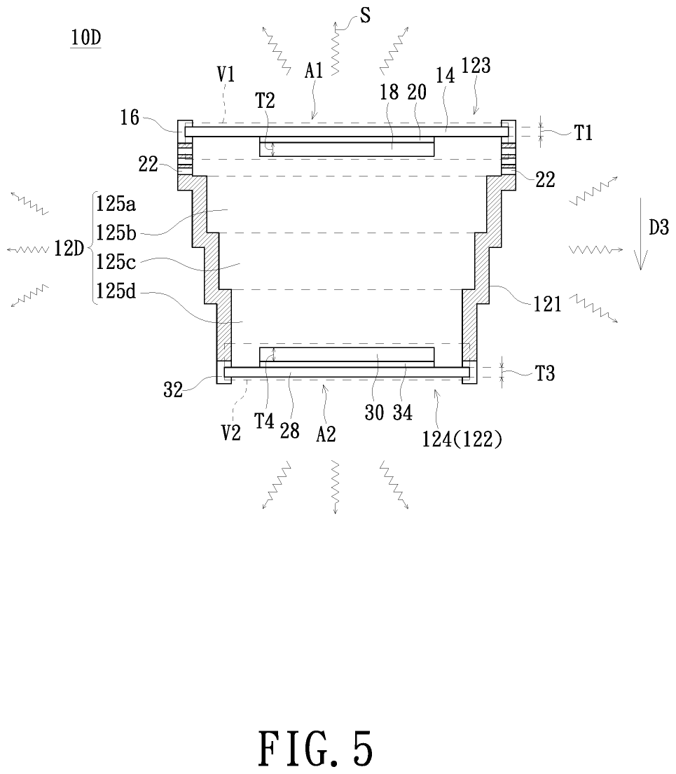

FIG. 5 is a schematic cross-sectional diagram of a speaker in the fifth embodiment of the present invention. As shown in FIG. 5, the speaker 10D further includes a second diaphragm 28, and a second piezoelectric vibrating element 30, in addition to the telescopic sound chamber 12D, the first diaphragm 14, and the first piezoelectric vibrating element 18. Unlike the telescopic sound chamber 12 shown in FIG. 1A, the telescopic sound chamber 12D shown in FIG. 5 is formed with a second opening 124 on the bottom layer 122 thereof, and there is a pressure regulating hole 22 on the box wall 121. In an embodiment, the first opening 123 and the second opening 124 are formed at the opposite ends of the telescopic sound chamber 12D, respectively. The telescopic sound chamber 12D includes a plurality of telescopic sub-box layers, taking four telescopic sub-box layers 125a, 125b, 125c, and 125d as an example in the figures, but is not limited thereto. The first diaphragm 14 and the second diaphragm 28 are arranged on the box wall 121 with a first support element 16 and a second support element 32 arranged around the circumferences of the first diaphragm 14 and the second diaphragm 28 and cover the first opening 123 and the second opening 124 to form a first coverage area A1 and a second coverage area A2, respectively. The first piezoelectric vibrating element 18 and the second piezoelectric vibrating element 30 are attached to the first diaphragm 14 and the second diaphragm 28 with a first connecting adhesive layer 20 and a second connecting adhesive layer 34, respectively. The first piezoelectric vibrating element 18 and the second piezoelectric vibrating element 30 are opposite inside the telescopic sound box 12D.

Continue with the above description. In the speaker 10D of the fifth embodiment as shown in FIG. 5, the four telescopic sub-box layers 125a, 125b, 125c, and 125d of the telescopic sound chamber 12D decrease in volume layer by layer in the direction D3 from the first opening 123 to the second opening 124. The smallest telescopic sub-box layer 125d is connected to the second opening 124. In another embodiment, the telescopic sub-box layers 125a, 125b, 125c, and 125d each present a rectangular outline on the longitudinal plane of the direction D3. In other embodiments not shown, the telescopic sub-box layers 125a, 125b, 125c, and 125d may each present a trapezoid outline on the longitudinal plane of the direction D3.

The telescopic sound chamber 12D has a minimum volume C when the telescopic sub-box layers 125a, 125b, 125c, and 125d of the telescopic sound chamber 12D are accommodated layer by layer. The first diaphragm 14 has the first diaphragm thickness T1. The second diaphragm 28 has the second diaphragm thickness T3. The first piezoelectric vibrating element 18 has the first element thickness T2. The second piezoelectric vibrating element 30 has the second element thickness T4. The sum of the first diaphragm thickness T1 and the first element thickness T2 is the first total thickness. The sum of the second diaphragm thickness T3 and the second element thickness T4 is the second total thickness. The first diaphragm thickness T1 is less than or equal to the first element thickness T4. The second element thickness T3 is less than or equal to the second element thickness T4. The product of the first coverage area A1 and the first total thickness defines the first spatial volume V1. The product of the second coverage area A2 and the second total thickness defines the second spatial volume V2. The minimum volume C of the telescopic sound chamber 12D is greater than twice the sum of the first spatial volume V1 and the second spatial volume V2.

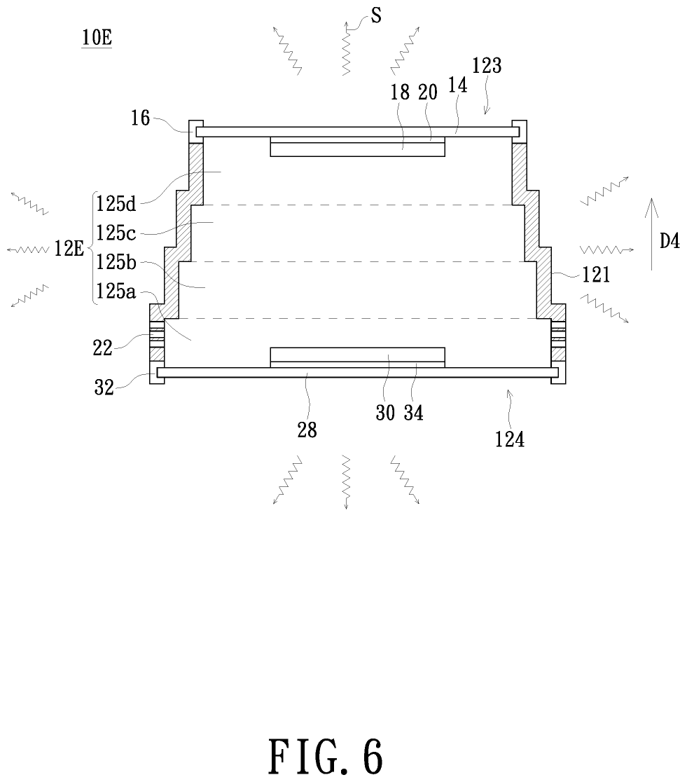

FIG. 6 is a schematic cross-sectional diagram of a speaker in the sixth embodiment of the present invention. The difference between the speaker 10E in FIG. 6 and the speaker 10D in FIG. 5 is that in the speaker 10E shown in FIG. 6, the telescopic sub-box layers 125a, 125b, 125c, and 125d of the telescopic sound chamber 12E decrease in volume layer by layer in the direction D4 from the second opening 124 to the first opening 123. The largest telescopic sub-box layer 125a is connected to the second opening 124.

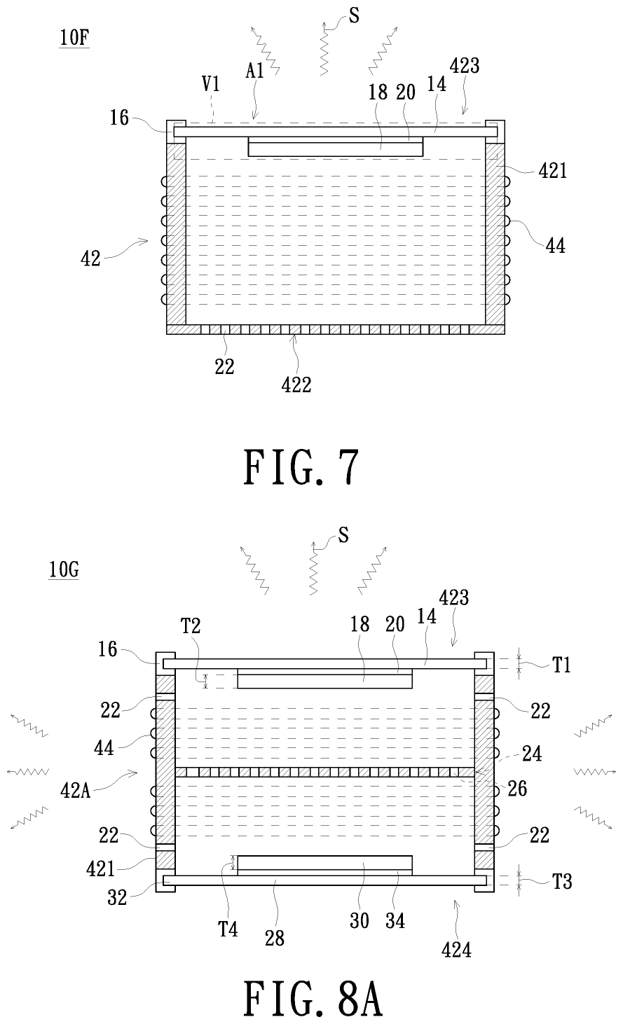

FIG. 7 is a schematic cross-sectional diagram of a speaker in the seventh embodiment of the present invention. As shown in FIG. 7, the difference between the speaker 10F of the seventh embodiment and the speaker 10 shown in FIG. 1A is that the telescopic sound chamber 42 of the speaker 10F includes a bellows tube body 44. The bellows tube body 44 has a box wall 421 extending along the axis and two opposite ends. The two opposite ends are formed with the first opening 423 and the bottom layer 422, respectively. The bottom layer 422 has one or a plurality of air pressure regulating holes 22. The height variation of the box wall 421 along the axis can cause changes in the volume of the bellows tube body 44. Specifically, the volume of the bellows tube body 44 decreases when the first opening 423 is close to the bottom layer 422; and the volume of the bellows tube body 44 increases when the first opening 423 is away from the bottom layer 422.

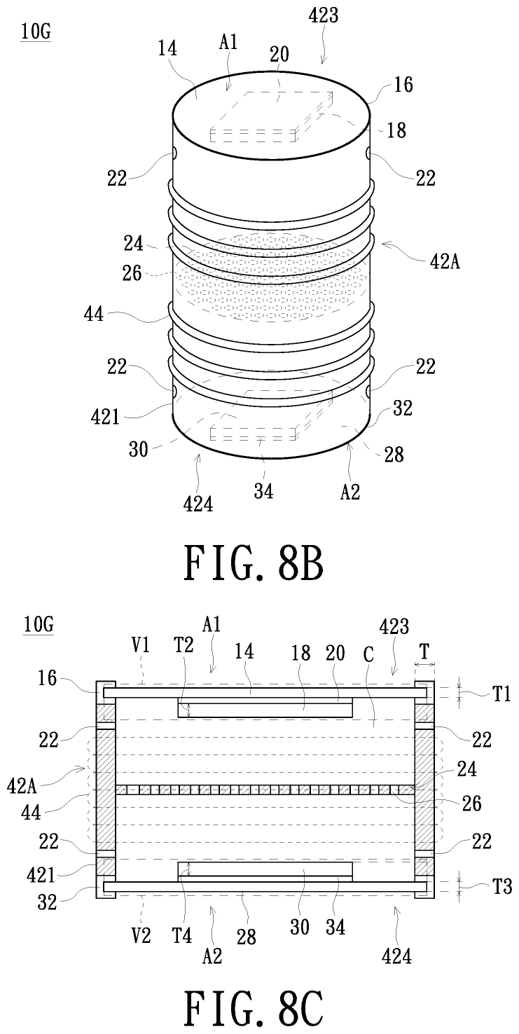

FIG. 8A is a schematic cross-sectional diagram of a speaker in the eighth embodiment of the present invention. FIG. 8B is a schematic three-dimensional diagram of the speaker in the eighth embodiment of the present invention. As shown in FIGS. 8A and 8B, the speaker 10G includes a telescopic sound chamber 42A, a first diaphragm 14, a second diaphragm 28, a first piezoelectric vibrating element 18, and a second piezoelectric vibrating element 30. The telescopic sound chamber 42A includes a bellows tube body 44, a first opening 423, and a second opening 424. The bellows tube body 44 has a box wall 421 extending along the axis and two opposite ends. The box wall 421 is provided with one or a plurality of air pressure regulating holes 22. The two opposite ends are defined as the first opening 423 and the second opening 424, respectively. The first diaphragm 14 and the second diaphragm 28 are arranged on the box wall 421 with a first support element 16 and a second support element 32 arranged around the circumferences of the first diaphragm 14 and the second diaphragm 28 and cover the first opening 423 and the second opening 424. The first diaphragm 14 and the second diaphragm 28 have a first coverage area A1 and a second coverage area A2, respectively. The first piezoelectric vibrating element 18 and the second piezoelectric vibrating element 30 are attached to the first diaphragm 14 and the second diaphragm 28 with a first connecting adhesive layer 20 and a second connecting adhesive layer 34, respectively. The first piezoelectric vibrating element 18 and the second piezoelectric vibrating element 30 are opposite inside the telescopic sound box 42A.

Continue with the above description. As shown in FIG. 8A, the first diaphragm 14 has a first diaphragm thickness T1. The second diaphragm 28 has a second diaphragm thickness T3. The first piezoelectric vibrating element 18 has a first element thickness T2. The second piezoelectric vibrating element 30 has a second element thickness T4. The first diaphragm thickness T1 is less than or equal to the first element thickness T2, and the second diaphragm thickness T3 is less than or equal to the second element thickness T4.

As shown in FIGS. 8A and 8B, the speaker 10G further includes a pressure regulating layer 24 arranged in the telescopic sound chamber 42A. A plurality of air holes 26 are formed on the pressure regulating layer 24. In addition, one or a plurality of air pressure regulating holes 22 are arranged on the box wall 421. In an embodiment, the air pressure regulating hole 22 is arranged on the part of the box wall 421 of the telescopic sound chamber 42A near the first opening 423 or/and the second opening 424.

FIG. 8C is a schematic diagram of the speaker in the eighth embodiment of the present invention in which the speaker has the minimum volume. As shown in FIG. 8C, the volume of the telescopic sound chamber 42A of the speaker 10G can vary with the height of the bellows tube body 44 along the axis. Specifically, when the first opening 423 and the second opening 424 are close to each other due to the contraction of the box wall 421 along the axis, the volume of the telescopic sound chamber 42A decreases and therefore forming the minimum volume C. When the first opening 423 and the second opening 424 are away from each other due to the extension of the box wall 421 along the axis, the volume of the telescopic sound chamber 42A increases. Referring to FIGS. 8A and 8C, the sum of the first diaphragm thickness T1 and the first element thickness T2 is the first total thickness. The sum of the second element thickness T3 and the second element thickness T4 is the second total thickness. The product of the first coverage area A1 and the first total thickness defines the first spatial volume V1. The product of the second coverage area A2 and the second total thickness defines the spatial volume V2. The minimum volume C is greater than twice the sum of the first spatial volume V1 and the second spatial volume V2.

Continue with the above description. Referring to FIG. 8C, the box wall 421 has a box wall thickness T. In order for the box wall 421 to support the first diaphragm 14, the first support element 16, and the first piezoelectric vibrating element 18, or to support the second diaphragm 28, the second support element 32, and the second piezoelectric vibrating element 30 when the speaker 10G is up-side-down, the box wall thickness T is greater than twice the first element thickness T2 or twice the second element thickness T4 (determined by the thicker one).

In the above embodiments, the material of the box wall 121/421 is, for example, polyethylene, polypropylene, or paper, and the bottom layer 122/422 or the air pressure regulating layer 24 can be formed by using the same material as the box wall 121/421 and integrally formed with the box wall 121/421. Alternatively, the material of the bottom layer 122/422 or the air pressure regulating layer 24 may be different from the material of the box wall 121/421, and the material of the bottom layer 122/422, and the air pressure regulating layer 24 may be metal, ceramic, glass, woven fabric, etc. The bottom layer 122/422, or the pressure regulating layer 24 can be attached to the box wall 121/421. On the other hand, the internal structure of the box wall 121/421 can be solid, hollow, or honeycomb-like.

In the above embodiments, the material of the first diaphragm 14 and the second diaphragm 28 are polyethylene or polypropylene.

In the above embodiments, the rigidity of the box wall 121/421 is greater than or equal to the rigidity of the first diaphragm 14 and the second diaphragm 28, and the rigidity of the box wall 121/421 and the rigidity of the first diaphragm 14 and the second diaphragm 28, are between 10 N/m and 200 N/m.

In the above embodiments, the shapes of the first openings 123, 423, the second openings 124, 424, and the bottom layers 122, 422 can be polygonal, circular, or elliptical. The shapes covered by the first diaphragm 14 and the second diaphragm 28 correspond to the shapes of the first openings 123, 423, and the second openings 124, 424, respectively.

According to the above description, the telescopic sound chamber of the speaker of an embodiment of the present invention can be composed of a plurality of telescopic sub-box layers or uses a bellows tube structure as the body. The quantity of the diaphragm and the quantity of the piezoelectric vibrating element can be one, and the diaphragm and the piezoelectric vibrating element can be arranged at the single open end of the speaker. Or, the quantity of the diaphragms and the quantity of the piezoelectric vibrating elements can be two, and the diaphragms and the piezoelectric vibrating elements can be arranged at the two open ends of the speaker. The speaker of an embodiment of the present invention utilizes a telescopic sound chamber that can change the internal spatial volume and the air pressure adjustment hole or air pressure adjustment layer, so that the speaker can provide a full audio, high volume, and smooth sound pressure signal, which can improve the distortion of the piezoelectric speaker in the low-frequency range.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A speaker, comprising:
a telescopic sound chamber, having a box wall, a bottom layer, and a first opening, wherein the bottom layer and the first opening are opposite to each other, the telescopic sound chamber comprises a plurality telescopic sub-box layers, the telescopic sub-box layers are sleeved on and connected to each other, the telescopic sub-box layers decrease in volume layer by layer, the telescopic sound chamber is suitable for accommodating the relatively smaller telescopic sub-box layer into the respective relatively larger telescopic sub-box layer to reduce a volume of the telescopic sound chamber, the telescopic sound chamber is suitable for moving the relatively smaller telescopic sub-box layer away the respective relatively larger telescopic sub-box layer to increase the volume of the telescopic sound chamber, and at least one of the box wall and the bottom layer is formed with at least one air pressure regulating hole;
a first diaphragm, arranged on the box wall to cover the first opening; and
a first piezoelectric vibrating element, arranged on the first diaphragm, facing the bottom layer, and accommodated in the telescopic sound chamber.

2. The speaker according to claim 1, wherein the volumes of the telescopic sub-box layers decrease layer by layer in a direction from the first opening to the bottom layer.

3. The speaker according to claim 1, wherein the volumes of the telescopic sub-box layers decrease layer by layer in a direction from the bottom layer to the first opening.

4. The speaker according to claim 1, wherein each of the telescopic sub-box layers has a rectangular or trapezoidal outline on a longitudinal plane of a direction from the first opening to the bottom layer.

5. The speaker according to claim 1, further comprising a first connecting adhesive layer arranged between the first piezoelectric vibrating element and the first diaphragm.

6. The speaker according to claim 1, further comprising a first support element arranged around a circumference of the first diaphragm, wherein the first diaphragm is connected to the box wall through the first support element to cover the first opening.

7. The speaker according to claim 1, wherein the bottom layer seals an end of the telescopic sound chamber far from the first opening, and the at least one air pressure regulating hole is formed on the bottom layer.

8. The speaker according to claim 1, wherein a material of the box wall and a material of the bottom layer are the same, and the box wall and the bottom layer are integrally formed.

9. The speaker according to claim 1, wherein a material of the box wall and a material of the bottom layer are different, and the bottom layer is attached to the box wall.

10. The speaker according to claim 1, wherein the telescopic sound chamber has a minimum volume by accommodating the relatively smaller telescopic sub-box layer into the respective relatively larger telescopic sub-box layer layer by layer, the first diaphragm covering the first opening has a first coverage area, the first diaphragm has a first diaphragm thickness, the first piezoelectric vibrating element has a first element thickness, a sum of the first diaphragm thickness and the first element thickness is a first total thickness, a product of the first coverage area and the first total thickness defines a first spatial volume, and the minimum volume is greater than twice the first spatial volume.

11. The speaker according to claim 10, wherein the box wall has a box wall thickness, the box wall thickness is greater than twice the first element thickness, and the first diaphragm thickness is less than or equal to the first element thickness.

12. The speaker according to claim 1, further comprising a second diaphragm and a second piezoelectric vibrating element, wherein a second opening is formed on the bottom layer of the telescopic sound chamber, the second opening is opposite to the first opening, the second diaphragm is arranged on the box wall to cover the second opening, the second piezoelectric vibrating element is arranged on the second diaphragm, faces the first opening, and is accommodated in the telescopic sound chamber, and the at least one air pressure regulating hole is formed on the box wall.

13. The speaker according to claim 12, wherein a quantity of the at least one air pressure regulating hole is plural, and the air pressure regulating holes at least are symmetrically formed on a part of the box wall corresponding to the largest telescopic sub-box layer.

14. The speaker according to claim 12, further comprising a second connecting adhesive layer arranged between the second piezoelectric vibrating element and the second diaphragm.

15. The speaker according to claim 12, further comprising a second support element arranged around a circumference of the second diaphragm, wherein the second diaphragm is connected to the box wall through the second support element to cover the second opening.

16. The speaker according to claim 12, wherein the telescopic sound chamber has a minimum volume by accommodating the relatively smaller telescopic sub-box layer into the respective relatively larger telescopic sub-box layer layer by layer, the first diaphragm covering the first opening has a first coverage area, the second diaphragm covering the second opening has a second coverage area, the first diaphragm has a first diaphragm thickness, the second diaphragm has a second diaphragm thickness, the first piezoelectric vibrating element has a first element thickness, the second piezoelectric vibrating element has a second element thickness, a sum of the first diaphragm thickness and the first element thickness is a first total thickness, a sum of the second diaphragm thickness and the second element thickness is a second total thickness, a product of the first coverage area and the first total thickness defines a first spatial volume, a product of the second coverage area and the second total thickness defines a second spatial volume, and the minimum volume is greater than twice a sum of the first spatial volume and the second spatial volume.

17. The speaker according to claim 16, wherein the box wall has a box wall thickness, the box wall thickness is greater than twice the second element thickness, and the second diaphragm thickness is less than or equal to the second element thickness.

18. The speaker according to claim 12, wherein a material of the first diaphragm and the second diaphragm is polyethylene or polypropylene, and a material of the box wall is polyethylene, polypropylene or paper.

19. The speaker according to claim 1, wherein a structure of the box wall is solid, hollow, or honeycomb-like.

20. The speaker according to claim 1, wherein a rigidity of the box wall is greater than or equal to a rigidity of the first diaphragm, and the rigidity of the box wall and the rigidity of the first diaphragm are between 10 N/m and 200 N/m.

21. A speaker, comprising:
a telescopic sound chamber, comprising a bellows tube body, wherein the bellows tube body has a box wall, a first end, and a second end opposite to the first end, the box wall extends along an axis, the first end forms a first opening, the second end forms a bottom layer, a volume of the bellows tube body is suitable for changing with a height of the box wall in the axis, and at least one of the box wall and the bottom layer is formed with at least one air pressure regulating hole;
a first diaphragm, arranged on the box wall to cover the first opening; and
a first piezoelectric vibrating element, arranged on the first diaphragm, facing the bottom layer, and accommodated in the telescopic sound chamber.

22. The speaker according to claim 21, further comprising a first connecting adhesive layer arranged between the first piezoelectric vibrating element and the first diaphragm.

23. The speaker according to claim 21, further comprising a first support element arranged around a circumference of the first diaphragm, wherein the first diaphragm is connected to the box wall through the first support element to cover the first opening.

24. The speaker according to claim 21, wherein the bottom layer seals an end of the bellows tube body far from the first opening, and the at least one air pressure regulating hole is formed on the bottom layer.

25. The speaker according to claim 21, wherein a volume of the bellows tube body is adapted to change with a height change of the box wall along the axis, so that the telescopic sound chamber has a minimum volume, the first diaphragm covering the first opening has a first coverage area, the first diaphragm has a first diaphragm thickness, the first piezoelectric vibrating element has a first element thickness, a sum of the first diaphragm thickness and the first element thickness is a first total thickness, a product of the first coverage area and the first total thickness defines a first spatial volume, and the minimum volume is greater than twice the first spatial volume.

26. The speaker according to claim 21, further comprising a second diaphragm and a second piezoelectric vibrating element, wherein a second opening is formed on the bottom layer, the second opening is opposite to the first opening, the second diaphragm is arranged on the box wall to cover the second opening, the second piezoelectric vibrating element is arranged on the second diaphragm, faces the second opening, and is accommodated in the telescopic sound chamber, and the at least one air pressure regulating hole is formed on the box wall.

27. The speaker according to claim 26, further comprising a second connecting adhesive layer arranged between the second piezoelectric vibrating element and the second diaphragm.

28. The speaker according to claim 26, further comprising a second support element arranged around a circumference of the second diaphragm, wherein the second diaphragm is connected to the box wall through the second support element to cover the second opening.

29. The speaker according to claim 26, wherein a quantity of the at least one air pressure regulating hole is plural, and the air pressure regulating holes at least are symmetrically formed on a part of the box wall close to the first opening and the second opening.

30. The speaker according to claim 26, wherein the telescopic sound chamber further comprises a pressure regulating layer, the pressure regulating layer is located in the telescopic sound chamber to divide the telescopic sound chamber, and the pressure regulating layer is formed with a plurality of air holes.

31. The speaker according to claim 30, wherein a material of the bottom layer and the air pressure regulating layer is selected from one of metal, ceramic, glass, or woven fabric.

32. The speaker according to claim 26, wherein a volume of the bellows tube body is adapted to change with a height change of the box wall along the axis, so that the telescopic sound chamber has a minimum volume, the first diaphragm covering the first opening has a first coverage area, the second diaphragm covering the second opening has a second coverage area, the first diaphragm has a first diaphragm thickness, the second diaphragm has a second diaphragm thickness, the first piezoelectric vibrating element has a first element thickness, the second piezoelectric vibrating element has a second element thickness, a sum of the first diaphragm thickness and the first element thickness is a first total thickness, a sum of the second diaphragm thickness and the second element thickness is a second total thickness, a product of the first coverage area and the first total thickness defines a first spatial volume, a product of the second coverage area and the second total thickness defines a second spatial volume, and the minimum volume is greater than twice a sum of the first spatial volume and the second spatial volume.
